(19) United States
(12) Patent Application Publication
(10) Pub. No.: US 2026/0223031 A1
(43) Pub. Date: Jul. 30, 2026

(54) SIGNAL FORWARDING METHOD AND REPEATER

(71) Applicant: 1FINITY Inc., Kawasaki-shi (JP)

(72) Inventors: Qinyan JIANG, Beijing (CN); Lei ZHANG, Beijing (CN); Xin WANG, Beijing (CN)

(73) Assignee: 1FINITY Inc., Kawasaki-shi (JP)

(21) Appl. No.: 19/629,137

(22) Filed: Mar. 26, 2026

Related U.S. Application Data
(63) Continuation of application No. PCT/CN2023/122971, filed on Sep. 28, 2023.

(51) Int. Cl. H04W 56/00; H04L 1/1812; H04W 72/21; H04W 72/23; H04W 88/04

(52) U.S. Cl. CPC H04W 56/0045; H04L 1/1812; H04W 72/21; H04W 72/23; H04W 88/04

(57) ABSTRACT

A signal forwarding apparatus, applicable to a repeater, includes: a mobile termination (MT) configured to receive a timing advance command, the timing advance command indicating an index value T_{A} for controlling a first timing; and forwarding entity configured to transmit a signal on a backhaul link by using the first timing, wherein the repeater is an RF repeater, the mobile termination is used to communicate with a network device via a control link, and the forwarding entity is used to forward an RF signal between a network device and a user equipment via the backhaul link and an access link.

### CROSS-REFERENCE TO RELATED APPLICATION

This application is a continuation application under 35 U.S.C. 111 (a) of International Patent Application PCT/CN2023/122971 filed on Sep. 28, 2023, and designated the U.S., the entire contents of which are incorporated herein by reference.

### TECHNICAL FIELD

This disclosure relates to the field of communication technologies.

### BACKGROUND

Compared with legacy 3G (third generation mobile communication technology) and 4G (fourth generation mobile communication technology) systems, a 5G (fifth generation mobile communication technology) system is able to provide larger bandwidths and higher data rates, and is able to support more types of terminals and vertical services.

For this reason, 5G systems are also deployed at new spectrum in addition to legacy telecommunications spectrum, and frequencies of the spectrum are obviously higher than those of legacy telecommunications spectrum used in 3G and 4G systems. For example, a 5G system may be deployed in a millimeter waveband (such as 28 GHZ, 38 GHz, 60 GHz, and higher wavebands).

According to the principle of propagation of wireless signals, the higher a carrier frequency, the more severe a fading experienced by signals during transmission. Therefore, in actual deployment, a 5G system needs a cell coverage enhancement method more than 3G and 4G systems need, especially a 5G system deployed in a millimeter waveband. Hence, how to better enhance cell coverage of a 5G system has become an urgent problem to be solved.

It should be noted that the above description of the background is merely provided for clear and complete explanation of this disclosure and for easy understanding by those skilled in the art. And it should not be understood that the above technical solution is known to those skilled in the art as it is described in the background of this disclosure.

### SUMMARY

In order to better solve the coverage problem of cellular mobile communication systems in practical deployment, use of a radio frequency (RF) relay/repeater to amplify and forward signals between a terminal equipment (UE) and a network device is commonly used means of deployment. RF repeaters are widely used in actual deployment of 3G and 4G systems. Generally speaking, an RF repeater is a device that amplifies and forwards signals between devices in the RF domain. That is, an RF repeater is a non-regenerative relay node, which only directly amplifies and forwards all received signals.

It was found by the inventors that for a coverage problem encountered in deploying a 5G system, performing coverage enhancement by using an RF repeater is one of feasible solutions. However, as a forwarding behavior of a legacy RF repeater is not controlled by a network, on the one hand, an effect of amplifying and forwarding a target signal by the repeater may possibly be not ideal, and on the other hand, it may pose significant interference to other devices in the network, and increase noise and interference levels of the system, thereby reducing network throughput. Specifically, taking an antenna direction as an example, compared to 2G, 3G and 4G systems, a 5G system adopts the more advanced and complex MIMO (multiple-input multiple-output) technology. In the 5G system, especially for higher carrier frequencies, directional antennas have become basic components of a network device and a terminal equipment. Transmitting and receiving signals based on a beamforming technology is a fundamental signal transmission mode in the 5G system. (Simulated) beam directions and widths, etc., of the network device and terminal equipment may dynamically change (i.e. beam switching) due to such factors as changes of positions. However, antennas of a legacy RF repeater may not be dynamically adjusted with respect to directions and have relatively wide beams, and beam directions and beam widths of transmitting and receiving antennas of the RF repeater are unable to flexibly match positions of the network device and terminal equipment and dynamic changes of the beam directions and widths of the transmitting and receiving antennas. If such an RF repeater is configured in the 5G system, on the one hand, its performance/effect of amplifying/enhancing target signals is/are not significant due to that the beam directions and beam widths of its transmitting and receiving antennas do not match the beam directions and beam widths of the network device and terminal equipment, and on the other hand, it may also cause significant interference to other devices (e.g. a network device or a terminal equipment) within a larger range due to use of wider transmitting beams, and increase noise and interference levels of the entire system, thereby reducing network throughput.

A network controlled repeater (NCR) scheme is proposed in 3GPP Rel-18 to enhance NR coverage, so as to forward signals between a network device and a terminal equipment. NCR may directly communicate with the network device via control links to assist in forwarding operations of the NCR. Currently, how to control forwarding operations of the NCR has become urgent problem to be solved. For example, such problems as how to control an NCR to perform forwarding by using what timing, when to perform forwarding and what beams are used in performing forwarding need to be urgently solved.

In order to solve at least one of the above problems, embodiments of this disclosure provide a signal forwarding method and a repeater.

According to one aspect of the embodiments of this disclosure, there is provided a signal forwarding apparatus, applicable to a repeater, including:
a mobile termination configured to receive a timing advance command, the timing advance command indicating an index value T_{A} for controlling a first timing; and
a forwarding unit configured to transmit a signal on a backhaul link by (only) using the first timing.

According to another aspect of the embodiments of this disclosure, there is provided a signal forwarding apparatus, applicable to a repeater, including:
a mobile termination configured to communicate with a network; and
a forwarding unit configured to forward a signal,
wherein when a time alignment timer expires,
the forwarding unit performs forwarding does not perform forwarding or stops forwarding, and/or
the mobile termination determines that a radio link failure (RLF) is detected, and/or
the mobile termination initiates radio resource control (RRC) connection reestablishment, and/or
the mobile termination initiates a random access procedure, and/or
a lower layer of the mobile termination transmits an indication of expiration of the time alignment timer and/or an RLF and/or a problem of time alignment to a higher layer, and/or
the mobile termination enters an RRC idle state.

According to a further aspect of the embodiments of this disclosure, there is provided a communication system, including a repeater, the repeater including the signal forwarding apparatus as described above.

An advantage of the embodiments of this disclosure exists in that the NCR may perform or may not perform forwarding. Hence, the forwarding unit is enabled not to perform forwarding under specific situations, and corresponding time domain resources/beams in performing forwarding match with time domain resources/beams of data transmission between the network device and the terminal equipment, thereby saving power consumption of the repeater, reducing interference, and improving network throughput.

With reference to the following description and drawings, the particular embodiments of this disclosure are disclosed in detail, and the principle of this disclosure and the manners of use are indicated. It should be understood that the scope of the embodiments of this disclosure is not limited thereto. The embodiments of this disclosure contain many alternations, modifications and equivalents within the spirits and scope of the terms of the appended claims.

Features that are described and/or illustrated with respect to one embodiment may be used in the same way or in a similar way in one or more other embodiments and/or in combination with or instead of the features of the other embodiments.

It should be emphasized that the term “comprises/comprising/including/include” when used in this specification is taken to specify the presence of stated features, integers, steps or components but does not preclude the presence or addition of one or more other features, integers, steps, components or groups thereof.

### BRIEF DESCRIPTION OF THE DRAWINGS

Elements and features depicted in one drawing or embodiments of the disclosure may be combined with elements and features depicted in one or more additional drawings or embodiments. Moreover, in the drawings, like reference numerals designate corresponding parts throughout the several views and may be used to designate like or similar parts in more than one embodiment.

The drawings are included to provide further understanding of this disclosure, which constitute a part of the specification and illustrate the preferred embodiments of this disclosure, and are used for setting forth the principles of this disclosure together with the description. It is obvious that the accompanying drawings in the following description are some embodiments of this disclosure, and for those of ordinary skills in the art, other accompanying drawings may be obtained according to these accompanying drawings without making an inventive effort. In the drawings:

FIG. 1 is schematic diagram of a communication system of embodiments of this disclosure;

FIG. 2 is a schematic diagram of a signal forwarding method of embodiments of this disclosure;

FIG. 3 is a schematic diagram of a signal forwarding method of embodiments of this disclosure;

FIG. 4 is a schematic diagram of a signal forwarding method of embodiments of this disclosure;

FIG. 5 is a schematic diagram of a signal forwarding method of embodiments of this disclosure;

FIG. 6 is a schematic diagram of a signal forwarding method of embodiments of this disclosure;

FIG. 7 is a schematic diagram of a signal forwarding method of embodiments of this disclosure;

FIG. 8 is a schematic diagram of a signal forwarding apparatus of embodiments of this disclosure;

FIG. 9 is a schematic diagram of an electronic device of embodiments of this disclosure;

FIG. 10 is a schematic diagram of an information transmission apparatus of embodiments of this disclosure; and

FIGS. 11-13 are schematic diagrams of application times of a timing advance command of embodiments of this disclosure.

### DETAILED DESCRIPTION

These and further aspects and features of this disclosure will be apparent with reference to the following description and attached drawings. In the description and drawings, particular embodiments of the disclosure have been disclosed in detail as being indicative of some of the ways in which the principles of the disclosure may be employed, but it is understood that the disclosure is not limited correspondingly in scope. Rather, the disclosure includes all changes, modifications and equivalents coming within the spirit and terms of the appended claims.

In the embodiments of this disclosure, terms “first”, and “second”, etc., are used to differentiate different elements with respect to names, and do not indicate spatial arrangement or temporal orders of these elements, and these elements should not be limited by these terms. Terms “and/or” include any one and all combinations of one or more relevantly listed terms. Terms “contain”, “include” and “have” refer to existence of stated features, elements, components, or assemblies, but do not exclude existence or addition of one or more other features, elements, components, or assemblies.

In the embodiments of this disclosure, single forms “a”, and “the”, etc., include plural forms, and should be understood as “a kind of” or “a type of” in a broad sense, but should not defined as a meaning of “one”; and the term “the” should be understood as including both a single form and a plural form, except specified otherwise. Furthermore, the term “according to” should be understood as “at least partially according to”, the term “based on” should be understood as “at least partially based on”, except specified otherwise.

In the embodiments of this disclosure, the term “communication network” or “wireless communication network” may refer to a network satisfying any one of the following communication standards: long term evolution (LTE), long term evolution-advanced (LTE-A), wideband code division multiple access (WCDMA), and high-speed packet access (HSPA), etc.

And communication between devices in a communication system may be performed according to communication protocols at any stage, which may, for example, include but not limited to the following communication protocols: 1G (generation), 2G, 2.5G, 2.75G, 3G, 4G, 4.5G, and 5G and new radio (NR) in the future, etc., and/or other communication protocols that are currently known or will be developed in the future.

In the embodiments of this disclosure, the term “network device”, for example, refers to a device in a communication system that accesses a user equipment to the communication network and provides services for the user equipment. The network device may include but not limited to the following devices: a base station (BS), an access point (AP), a transmission reception point (TRP), a broadcast transmitter, a mobile management entity (MME), a gateway, a server, a radio network controller (RNC), a base station controller (BSC), etc.

The base station may include but not limited to a node B (NodeB or NB), an evolved node B (eNodeB or eNB), and a 5G base station (gNB), etc. Furthermore, it may include a remote radio head (RRH), a remote radio unit (RRU), a relay, or a low-power node (such as a femto, and a pico, etc.). The term “base station” may include some or all of its functions, and each base station may provide communication coverage for a specific geographical area. And a term “cell” may refer to a base station and/or its coverage area, depending on a context of the term.

In the embodiments of this disclosure, the term “user equipment (UE)” refers to, for example, an equipment accessing to a communication network and receiving network services via a network device, and may also be referred to as “a terminal equipment (TE)”. The terminal equipment may be fixed or mobile, and may also be referred to as a mobile station (MS), a terminal, a subscriber station (SS), an access terminal (AT), an IAB-MT, or a station, etc.

The terminal equipment may include but not limited to the following devices: a cellular phone, a personal digital assistant (PDA), a wireless modem, a wireless communication device, a hand-held device, a machine-type communication device, a lap-top, a cordless telephone, a smart cell phone, a smart watch, and a digital camera, etc.

For another example, in a scenario of the Internet of Things (IoT), etc., the user equipment may also be a machine or a device performing monitoring or measurement. For example, it may include but not limited to a machine-type communication (MTC) terminal, a vehicle mounted communication terminal, a device to device (D2D) terminal, and a machine to machine (M2M) terminal, etc.

FIG. 1 is schematic diagram of an NCR of an embodiments of this disclosure. As shown in FIG. 1, NCR 102 is configured between a network device 101 and a terminal equipment 103. NCR 102 may include the following two modules/components: a mobile termination of a repeater (NCR-MT) and a forwarding unit of the repeater (NCR-Fwd). The NCR-Fwd may also be referred to as a routing unit of the NCR (NCR-RU). The NCR-MT is used for communication with the network device (information exchange), the NCR-Fwd is used for forwarding signals between the network device and the terminal equipment, and the NCR-MT and NCR-Fwd are functional entities, with functions thereof being implemented by identical or different hardware modules.

As shown in FIG. 1, the NCR of the embodiments of this disclosure may have three links: a control link (C-link), a backhaul link (BH-link) for forwarding, and an access link (AC-link, also referred to as an NCR-UE link), wherein the C-link is used for communication between the NCR and the network device, the BH-link is used by the repeater to receive signals to be forwarded from the network device, or forward signals from the terminal equipment to the network device, and the AC-link is used by the repeater to forward signals from the network device to the terminal equipment, or receive signals to be forwarded from the terminal equipment. Specifically, the NCR-MT communicates with the network device via the C-link, and the NCR-Fwd forwards signals via the BH-link and the AC-link.

In the embodiments of this disclosure, the repeater may also be expressed as a network-controlled repeater (NCR), a radio frequency repeater, a relay, a radio frequency relay; or, it may also be expressed as a repeater node, or a relay node; or, it may also be expressed as an intelligent repeater, an intelligent relay, an intelligent repeater node, an intelligent relay node, etc.; however, this disclosure is not limited thereto.

In the embodiments of this disclosure, the network device may be a device of a serving cell of the terminal equipment, or a device in a cell where the repeater is located, or a device of a serving cell of the repeater, or a parent node of the repeater. Names of the repeater are not limited in this disclosure, and any device able to achieve the above functions is included in the scope of the repeater of this disclosure.

In the embodiments of this disclosure, higher layer signaling may be, for example, radio resource control (RRC) signaling; for example, it includes an RRC message, which includes a master information block (MIB), system information, and a dedicated RRC message; or, it is an RRC information element (RRC IE); or an information field (or an information field included in an information field) included in an RRC message or an RRC information element. Higher-layer signaling may also be, for example, medium access control (MAC) signaling, or referred to as an MAC control element (MAC CE); however, this disclosure is not limited thereto.

In the embodiments of this disclosure, multiple means at least two, or two or more than two.

In the embodiments of this disclosure, “predefined” means defined in a protocol or determined according to a rule defined in a protocol, without needing additional configuration. Configuration/indication refer(s) to configuring/indicating directly or indirectly by a network device via high-layer signaling and/or physical layer signaling. The physical layer signaling refers to, for example, control information (DCI) carried by a physical control channel or control information carried by a sequence; however, it is not limited thereto.

Implementations of the embodiments of this disclosure shall be described below with reference to the accompanying drawings. These implementations are illustrative only, and are not intended to limit this disclosure.

### Embodiments of a First Aspect

It was found by the inventor that similar to a legacy UE, an NCR-MT also has different uplink transmission timings, but it has not yet been determined what timing an NCR-Fwd shall use for forwarding, such as if the NCR-Fwd uses one or more uplink transmission timings of the NCR-MT to transmit a signal on a BH link, when and which uplink transmission timing of the NCR-MT shall be used for forwarding.

The embodiments of this disclosure provide a signal forwarding method, which shall be described from a side of a repeater.

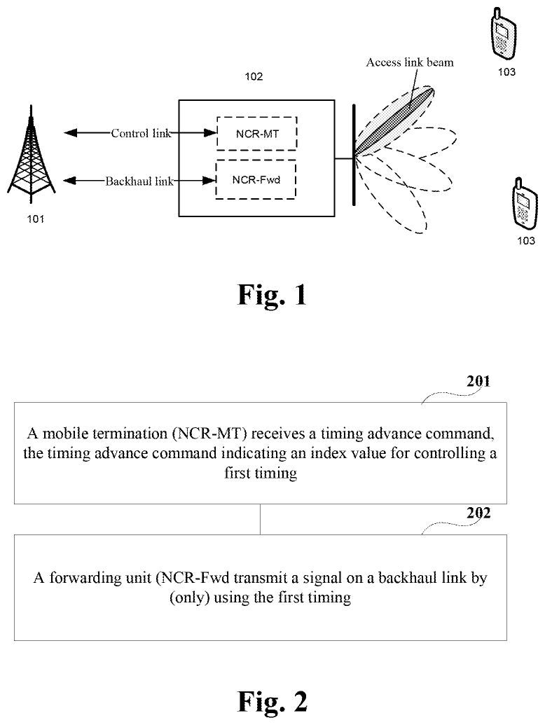

FIG. 2 is a schematic diagram of the signal forwarding method of the embodiments of this disclosure. As shown in FIG. 2, the method includes:
201: a mobile termination (NCR-MT) receives a timing advance command, the timing advance command indicating an index value T_{A} for controlling a first timing; and
202: a forwarding unit (NCR-Fwd) transmits a signal on a backhaul link by (only) using the first timing.

It should be noted that FIG. 2 only schematically illustrates the embodiments of this disclosure; however, this disclosure is not limited thereto. For example, an order of execution of the operations may be appropriately adjusted, and furthermore, some other operations may be added, or some operations therein may be reduced. And appropriate variants may be made by those skilled in the art according to the above contents, without being limited to what is contained in FIG. 2.

In some embodiments, the mobile termination of the repeater (hereinafter referred to as an NCR-MT) and the forwarding unit of the repeater (NCR-Fwd) are both functional entities within the repeater, and both the mobile termination of the repeater and the forwarding unit of the repeater may be referred to as repeaters.

In some embodiments, the NCR-MT has two types of (uplink) timings, including a first timing and a second timing, and the NCR-MT transmits a first signal on a control link by using the first timing, the first signal including a PUCCH and/or a PUSCH and/or an SRS, wherein the PUSCH does not include an MSGA PUSCH. The NCR-MT transmits a second signal on the control link by using the second timing, the second signal including a PRACH and/or an MSGA PUSCH, or, in other words, the second signal including a PRACH and/or an MSGA.

How to determine the first timing and the second timing shall be described below.

In some embodiments, the first timing and/or the second timing is/are relative to downlink timing advance (N_{TA}+N_{TA offset})×T_{c}; wherein a timing advance offset N_{TA,offset} of a serving cell is provided by first configuration information (e.g. n-TimingAdvanceOffset) of the serving cell. If the NCR-MT is not provided with the first configuration information, the NCR-MT declares that N_{TA,offset} is a default value (as shown in Table 1), and if the NCR-MT is configured with two uplink carriers for one serving cell, the two identical carriers apply identical N_{TA,offset}; for the first timing, N_{TA} is determined by the index value T_{A}, and for the second timing, N_{TA} is a default value (for example, the default value is 0), and T_{c}=1/(Δfₘₐₓ·N_{f}); where, Δfₘₐₓ=480·10³ Hz, and N_{f}=4096.

In some embodiments, the first timing and/or the second timing is/are relative to downlink timing advance

$$( {N}_{TA} + {N}_{TA , offset} + {N}_{TA , adj}^{common} + {N}_{TA , adj}^{UE} ) {T}_{c} ,$$

wherein a timing advance offset N_{TA,offset} of a serving cell is provided by first configuration information (e.g. n-TimingAdvanceOffset) of the serving cell. If the NCR-MT is not provided with the first configuration information, the NCR-MT declares that N_{TA,offset} is a default value (as shown in Table 1), and if the NCR-MT is configured with two uplink carriers for one serving cell, the two identical carriers apply identical N_{TA,offset}. For the first timing, N_{TA} is determined by the index value T_{A}, and for the second timing, N_{TA} is a default value (for example, the default value is 0).

$${N}_{TA , adj}^{common}$$

is provided by second configuration information (ta-Common, ta-CommonDrift, ta-CommonDriftVariant) or is a default value, and

$${N}_{TA , adj}^{UE}$$

is provided by third configuration information (a higher layer parameter related to serving satellite ephemeris) or is a default values; T_{c}=1/(Δfₘₐₓ·N_{f}); where, Δfₘₐₓ=480·10³ Hz, and N_{f}=4096.

In some embodiments, for the first timing and/or the second timing,

$${N}_{TA , adj}^{common} and / or {N}_{TA , adj}^{UE}$$

is/are default value(s) (for example, the default value is 0). That is, for the NCR, it is not (should not be) provided with the second configuration information and/or the third configuration information, hence, its corresponding

$${N}_{TA , adj}^{common} and / or {N}_{TA , adj}^{UE}$$

is/are default value(s) (for example, the default value is 0); however, this disclosure is not limited thereto.

In the above example, the default value of N_{TA,offset} is dependent on a duplex mode and frequency range of a cell performing uplink transmission, as shown in Table 1 below. In addition, for FR1, N_{TA,offset} is 25600 when the NCR-MT is not provided with the first configuration information. In case of multiple carriers, the NCR-MT expects that the first configuration information provides an identical value for all carriers, and the value 39936 of N_{TA,offset} may also be used for an FDD serving cell.

TABLE 1

| Frequency range and frequency band of | N_{TA offset} |
|---|---|
| the cell used for uplink transmission | (Unit: TC) |
| FR1 FDD or TDD frequency band, without | 25600 |
| coexistence of E-UTRA-NR and NB-IoT-NR | |
| FR1 FDD frequency band, with coexistence | 0 |
| of E-UTRA-NR and/or NB-IoT-NR | |
| FR1 TDD frequency band, with coexistence | 39936 |
| of E-UTRA-NR and/or NB-IoT-NR | |
| FR2 | 13792 |

In some embodiments, the timing advance command indicates an index value T_{A} used to control a timing adjustment amount applied by an MAC entity.

In some embodiments, the timing advance command indicates a change in uplink timing relative to current uplink timing.

In some embodiments, the timing advance command includes a first timing advance command and/or a second timing advance command, wherein the quantity of bits (e.g. 12 bits) included in the first timing advance command is greater than the quantity (e.g. 6 bits) of bits included in the second timing advance command. The first timing advance command may be transmitted via an RAR (such as an (MAC) RAR included in MSG2 (in 4-step RA) or FallbackRAR or SuccessRAR included in an MSGB (in 2-step RA)) or a first MAC CE (such as an absolute timing advance command MAC CE), and occupies 12 bits, with a value range of a corresponding index value T_{A} from 0 to 3846. The second timing advance command may be transmitted via a second MAC CE (such as a timing advance command MAC CE), and occupies 6 bits, with a value range of a corresponding index value T_{A} from 0 to 63.

For example, in an NCR-MT random access procedure, the index value T_{A} is indicated by a TAC (first timing advance command 12 bits) in an RAR or in a first MAC CE, for/based on a subcarrier spacing 2μ·15 KHz, N_{TA}=T_{A}·16·64/2^{μ}, wherein the subcarrier spacing is, for example, an SCS adopted by first uplink transmission (such as PUSCH/PUCH/SRS) after the NCR-MT receives the first timing advance command and/or a reference SCS (of a time domain resource) of a first forwarding resource. That is, N_{TA} is related to the SCS.

In random access, the NCR-MT obtains an initial first timing or an initial value of N_{TA} (for the first timing), but a position or a channel condition of the NCR-MT may change over time. The network equipment needs to maintain T_{A}, that is, indicating T_{A} by a TAC (second timing advance command 6 bits) of a second MAC CE, so as to indicate adjustment to a current N_{TA} value. For example, for/based on a subcarrier spacing 2^{μ}·15 kHz, N_{TA_new}=N_{TA_old}+(T_{A}−31)·16·64/24, N_{TA_old} is used before the second timing advance command received, and N_{TA_new} is updated after receiving the first timing advance command, wherein the subcarrier spacing is, for example, an SCS (such as a maximum SCS) in an active UL BWP(s), or an SCS (such as a maximum SCS) in reference SCSs in active UL BWP(s) and/or (time domain resources of) forwarding resources. The above active UL BWPs and/or forwarding resources are, for example, active UL BWPs to which a time when the NCR-MT applies the second timing advance command corresponds and/or forwarding resources (on which transmitted on the backhaul link or performed uplink forwarding by the NCR-Fwd or on which forwarded signals by the NCR-Fwd to the network device from a terminal equipment). For example, if the NCR-Fwd does not/has not perform (ed) transmission or uplink forwarding or forward (ed) signals from the terminal equipment to the network device on the backhaul link at that time, the subcarrier spacing is an SCS in active UL BWP(s); otherwise, it is an SCS in active UL BWP(s) and reference SCSs (of the time domain resource) of the forwarding resource.

As described above, the NCR-MT has two (uplink) timings, including a first timing and a second timing. It was found by the inventor that it is assumed that the NCR-Fwd uses a timing (such as the second timing) when a UE served by the NCR-Fwd transmits a PRACH/MsgA, and the gNB provides a timing advance command to the UE to control an uplink timing or timing advance of the UE. Then, if the NCR-Fwd uses the other timing (such as the first timing) when the UE transmits other UL transmissions by using the T_{A} command, from the perspective of the gNB, an arrival timing of the UL transmissions will be different from an expected arrival timing when it provides the T_{A} command. For example, it may arrive before the arrival timing expected by the gNB.

In some implementations, in order to solve the above problems, the forwarding unit (NCR-Fwd) transmits a signal on the backhaul link by only using the first timing, or, in other words, the forwarding unit does not transmit a signal on the backhaul link by using the second timing. Or, in other words, the NCR-Fwd transmits a signal on the backhaul link by using the timing determined by the NCR-MT by using the T_{A} command (=the first timing). That is, the NCR-Fwd should always use an identical timing in transmitting on the BH link, thereby avoiding a problem of UL timing of the UE served by the NCR-Fwd that may possibly arise from using different timings.

In some implementations, in order to solve the above problem, the NCR-Fwd should not use different UL timings (the first timing and the second timing) for transmission at different time positions in the BH link.

In some embodiments, as described above, the network device needs to maintain TA, and may possibly update N_{TA}, and N_{TA_new} and N_{TA_old} respectively obtain/correspond to two (uplink) timings. For the forwarding unit, if two adjacent (uplink) slots overlap due to the T_{A} command (for example, the former slot still uses a timing to which N_{TA_old} corresponds, the latter slot uses a timing to which N_{TA_new} corresponds, and the latter timing is advanced relative to the former timing), the latter slot is reduced in duration relative to the former slot, that is, due to two (uplink) slots overlap after T_{A} in the timing advance command determines N_{TA_new}, a duration of the latter (uplink) slot is reduced relative to the former (uplink) slot, that is, the forwarding unit forwards a signal to which the former (uplink) slot corresponds on the slot, and does not forward a signal to which the latter (uplink) slot corresponds at a time where the latter (uplink) slot and the former (uplink) slot overlap, or, discard a signal on a time where the latter (uplink) slot and the former (uplink) slot overlap, and still forwards the signal to which the latter (uplink) slot corresponds at a time where the latter (uplink) slot and the former (uplink) slot do not overlap, wherein the (uplink) slot is based on the reference SCS of (the time domain resource of) the forwarding resource.

In some embodiments, the repeater (forwarding unit/mobile termination) does not expect to change N_{TA} within one (uplink) slot, and the repeater uses identical N_{TA} in the uplink slot, wherein the (uplink) slot is based on the reference SCS of (the time domain resource of) the forwarding resource. The reference SCS may be determined according to a first parameter and/or a second parameter and/or a third parameter described later, which shall be described later in detail. The following examples are based on a slot of a certain SCS, or for the slot of the SCS, or with respect to/relative to the slot of the SCS.

In some embodiments, the repeater does not expect to change N_{TA} within a third time domain resource. Time domain resources included in the third time domain resource are continuous (or discontinuous). The time domain resources included in the third time domain resources are associated with identical (or different) beam indices, wherein the beam indices refer to beam indices for beams of an access link. For example, for uplink forwarding, the repeater does not expect to change N_{TA} within continuous time domain resources, and the repeater uses identical N_{TA} within continuous time domain resources; or, the repeater does not expect to change N_{TA} within time domain resources associated with identical beam indices, and the repeater uses identical N_{TA} in the time domain resources associated with an identical beam index; or, the repeater does not expect to change N_{TA} within continuous time domain resources associated with an identical beam index, and the repeater uses an identical N_{TA} in continuous time domain resources associated with an identical beam index; and in the third time domain resource, the forwarding unit transmits a signal on the backhaul link.

In some embodiments, for the timing advance command received on the first (uplink) slot, the timing advance command is applied from a start of the second (uplink) slot. For example, (in a case of other than random access) after the NCR-MT receives a timing advance command on a slot n (first slot), new timing advance is executed on a slot n+N_{offset} (second slot).

In some embodiments, the second (uplink) slot is determined according to the reference SCS of the forwarding resource, including that the first (uplink) slot is determined according to a first SCS related to the reference SCS, and/or that an offset N_{offset} of the second (uplink) slot relative to the first (uplink) slot is determined according to a second SCS related to the reference SCS, the first SCS and the second SCS being identical or different.

For example, the first SCS and/or the second SCS is/are an SCS (such as a minimum SCS) in SCSs of (all) UL BWPs configured (by (all uplink carriers) in a TAG associated with the timing advance command) (for the mobile termination) and (all or a part of) the reference SCSs configured (for periodic forwarding resources and/or semi-persistent forwarding resources and/or aperiodic forwarding resources) (for the repeater/forwarding unit). The first (uplink) slot is a last slot in uplink slot(s) based on the first SCS that overlap(s) with downlink slot(s) of (in which received) a PDSCH, the PDSCH providing the timing advance command. The offset N_{offset} includes a first offset k, for example, N_{offset}=k+1+2^{μ}·K_{offset}, or N_{offset}=k+1; however, it is not limited thereto; wherein the first offset

$$k = ⌈ {N}_{slot}^{subframe , μ} \cdot ( {N}_{T , 1} + {N}_{T , 2} + {N}_{TA , max} + 0.5 ) / {T}_{sf} ⌉ ;$$

where, N_{T,1} is a time corresponding to receiving N1 symbols by the PDSCH, N_{T,2} is a time corresponding to transmitting prepared received N2 symbols by the PUSCH, N_{TA,max} is a maximum T_{A} that may be provided by the timing advance command, and T_{sf} is a time of a subframe, wherein

$${N}_{slot}^{subframe , μ}$$

and/or 2^{μ} within one slot is/are determined according to the second SCS; where, μ is a numerology. K_{offset}=K_{cell,offset}−K_{UE,offset}; where, K_{cell,offset} is provided by a parameter cellSpecifickoffset, K_{UE,offset} is provided by a differential K_{offset} MAC CE command, and if not provided, they are set to be 0.

In some embodiments, for the NCR, it is not (should not be) provided with the parameter cellSpecifickoffset and the MAC CE command, hence, K_{offset} to which it corresponds is 0; however, this disclosure is not limited thereto.

Taking FIG. 11 as an example, it is assumed that the first SCS and the second SCS are identical, both are 15 kHz, and the SCS of the PDSCH providing the T_{A} command is 30 kHz. Assuming that T_{TA}=0, the first slot is an uplink slot based on the first SCS and overlapping with a downlink slot of the PDSCH, and the offset of the second slot applying the T_{A} command is also determined based on the second SCS.

In some embodiments, the second (uplink) slot is determined according to the reference SCS of forwarding resource, including that if a start of a third (uplink) slot (based on a fourth SCS) is within a slot of the third (uplink) slot based on the third SCS related to the reference SCS, the second (uplink) slot is after the third (uplink) slot, wherein the third (uplink) slot may be determined according to the first (uplink) slot. The second (uplink) slot is a first one of slots (based on a fourth SCS) after the third (uplink) slot with a start aligned with a slot based on the third SCS related to the reference SCS and/or a first one of slots (based on the fourth SCS) with a start that is not within a slot based on the third SCS related to the reference SCS, or the second (uplink) slot is a first one of slots (based on the third SCS) after a slot overlapping with the third (uplink) slot and/or a first one of slots (based on the third SCS) (not overlapping with the third (uplink) slot) after the third (uplink) slot.

For example, the third SCS is an SCS (such as a minimum SCS) in the configured reference SCSs (for all or a part of periodic forwarding resources and/or semi-persistent forwarding resources and/or aperiodic forwarding resources), and the fourth SCS is a minimum SCS in SCSs of (all) UL BWPs configured (by (all uplink carriers in) the TAG associated with the timing advance command) (for the mobile termination).

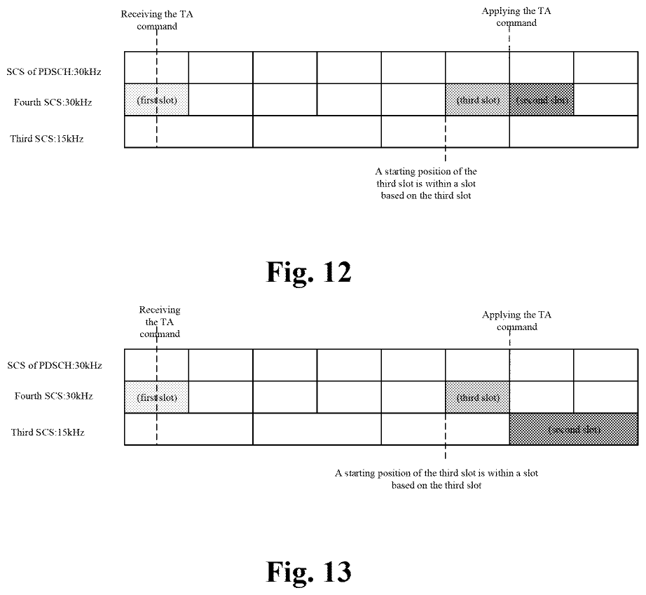

Taking FIG. 12 as an example, the fourth SCS is 30 kHz, the third SCS is 15 kHz, the SCS of the PDSCH providing the TA command is 30 kHz, the third slot is based on the fourth SCS, and it is determined according to the first slot that the second slot is a first one of slots based on the fourth SCS after the third slot. Taking FIG. 13 as an example, the fourth SCS is 30 kHz, the third SCS is 15 kHz, the SCS of the PDSCH providing the TA command is 30 kHz, the third slot is based on the fourth SCS, and it is determined according to the first slot that the second slot is a first one of slots based on the third SCS after the third slot.

In some embodiments, a DL reception timing of the NCR-Fwd (on the BH link) is aligned with a downlink reception timing of the NCR-MT (on the C-link).

In some embodiments, a downlink transmission timing of the NCR-Fwd (on the AC-link) is delayed by a certain time (such as internal delay) relative to a downlink reception timing of the NCR-Fwd (on the BH link) or the NCR-MT (on the C-link).

In some embodiments, an uplink transmission timing of the NCR-Fwd (on the AC-link) is advanced by a certain time (such as internal delay) relative to an uplink transmission timing of the NCR-Fwd (on the BH link) or the NCR-MT (on the C-link).

In some embodiments, the NCR-MT further receives a first DCI format, the first DCI format indicating time domain resources of the access link and corresponding beam indices. For example, the first DCI format may be DCI format 2_8, and a starting slot position of the time domain resources is a position starting from a reference slot offset by a first predetermined number of slots, a starting symbol position is a position offset by a second predetermined number of symbols within the starting slot position, the reference slot is a first one of slots after slot n+k (based on a reference subcarrier spacing, which is provided/indicated/configured by a third parameter referenceSCS-r18, which shall be explained later), and slot n is a slot receiving a PDCCH carrying the first DCI format. For example, thy may be expressed as:

The NCR-MT can be configured to monitor PDCCH according to USS sets for detection of a DCI format 2_8
with CRC scrambled by an NCR-RNTI. A time resource and a corresponding beam index for transmissions or
receptions on the access link are indicated by corresponding fields in DCI format 2_8. When the NCR detects
more than one DCI formats 2_8 that indicate beam indexes for time resources overlapping in a set of symbols, the
NCR uses for the set of symbols a beam index that is indicated by a DCI format 2_8 that the NCR-MT detects in
a most recent PDCCH monitoring occasion. The time resource starts at a slot that is offset by slotOffsetAperiodic
slots from a reference slot and at a symbol that is offset by symbolOffset from the start of the slot, and has a
duration provided by durationInSymbols for a SCS provided by referenceSCS in NCR-AperiodicFwdConfig. The
reference slot is the first slot for the SCS provided by referenceSCS in NCR-AperiodicFwdConfig that is after slot
n+k, where slot n refers to the slot of a PDCCH reception that provides the DCI format 2_8 and k is a number of
slots indicated by FG 43-3 for the SCS of the PDCCH carrying the DCI.

In some embodiments, the forwarding resources include beam indices and time domain resources, and the time domain resources of the forwarding resources may also be referred to as forwarding time domain resources.

In some embodiments, the repeater may receive a first indication indicating the time domain resources (of the forwarding resources), which may be a periodic beam indication, or a semi-persistent beam indication, or a dynamic (or aperiodic) beam indication.

For the periodic beam indication, a list of periodic forwarding resource configurations/sets is configured (including added or modified) via RRC signaling (such as pperiodicFwdRsrcSetToAddModList in NCR-FwdConfig), wherein a periodic forwarding resource configuration/set (e.g. configured/provided/indicated by an NCR-PeriodicFwdResourceSet in periodicFwdRsrcSetToAddModList) includes/provides/configures/indicates one list of forwarding resources (via periodicFwdRsrcToAdddModList and/or periodicFwdRsrcToReleaseList in NCR-PeriodicFwdResourceSet), one forwarding resource in the list (provided/indicated/configured by an NCR-PeriodicFwdResource in periodicFwdRsrcToAdddModList) may include one forwarding resource identification information periodicFwdRsrcId-r18 and/or one beam index information beamIndex-r18 and/or one period and offset information periodicityAndOffset-r18 and/or one symbol offset information symbolOffset-r18 and/or one time period information durationInSymbols-r18; furthermore, one periodic forwarding resource configuration may include one priority information priorityFlag (optional), and/or one first parameter referenceSCS-r18 (mandatory) for indicating the reference subcarrier spacing, wherein the indicated reference subcarrier spacing is a reference subcarrier spacing of all forwarding resources or forwarding time domain resources and/or one periodic forwarding resource set identification information periodicFwdRsrcSetId-r18 indicated for the periodic forwarding resource configuration; however, the embodiments of this disclosure is not limited thereto. That is, the network device may transmit one or more periodic forwarding resource configurations to the NCR, each periodic forwarding resource configuration respectively including the above information. For example, one configuration includes a priority flag, while another configuration does not. For another example, each configuration respectively includes a first parameter, and reference subcarrier spacings to which the first parameters correspond are identical or different.

In some embodiments, one periodic forwarding resource configuration may be referred to as one periodic beam indication, and they may be interchangeable.

For the semi-persistent beam indication, a method for configuring a list of forwarding resources by it via RRC signaling is similar to that of the periodic beam indication, with a difference that it includes a list of forwarding resources activated or deactivated by MAC CE. For example, one first MAC CE (e.g. an NCR access link beam indication MAC CE) activates or deactivates one semi-persistent forwarding resource list. One semi-persistent forwarding resource configuration/set includes/provides/configures/indicates a list of forwarding resources (e.g. via ncr-SemiPersistentFwdResourceToAdddModList-r18 and/or ncr-SemiPersistentFwdResourceToReleaseList-r18 in NCR-SemiPersistentFwdResourceSet). One forwarding resource in the list may include one priority information priorityFlag (optional) and/or a second parameter referenceSCS-r18 (mandatory) indicating a reference subcarrier spacing, the indicated reference subcarrier spacing being a reference subcarrier spacing for the semi-persistent forwarding resource. That is, the network device may transmit one or more semi-persistent forwarding resource configurations to the NCR, each semi-persistent forwarding resource configuration respectively including the above information. For example, one configuration includes a priority flag, while another configuration does not. For another example, each configuration respectively include a second parameter, and reference subcarrier spacings to which the second parameters correspond are identical or different.

For the aperiodic beam indication, the following may also be replaced with DCI, which may include one or more first information fields for indicating beam(s) and one or more second information fields for indicating time domain resource(s). The DCI (may) have/adopt the above first DCI format, which is only used for the repeater. The first DCI format is, for example, DCI format 2_8; however, it is not limited thereto. The second information field indicates time domain resources via a list of time domain resources. The list of time domain resources includes one or more time domain resource configurations, and the list of time domain resources includes a configuration of at least one time domain resource. One time domain resource is defined by, for example, one or more of the following parameters: a slot offset (slotOffsetAperiodic-r18, used for determining a starting slot in a slot), a symbol offset (symbolOffset-r18, used for determining a starting symbol in a slot), and a symbol number (durationInSymbols-r18, used for determining a duration of the time domain resource). For example, the list of time domain resources may be configured by RRC signaling NCR-AperiodicFwdConfig, such as including:

ncr-AperiodicFwdTimeResourceToAddModList-r18 SEQUENCE (SIZE (1..maxNrofAperiodicFwdTimeResource-r18)) OF NCR-
AperiodicFwdTimeResource-r18

OPTIONAL, -- Need N

ncr-AperiodicFwdTimeResourceToReleaseList-r18 SEQUENCE (SIZE (1..maxNrofAperiodicFwdTimeResource-r18)) OF NCR-
AperiodicFwdTimeResourceId-r18

```
    OPTIONAL, -- Need N
      OPTIONAL, -- Need M,
```

```
    ...
    ...
}
NCR-AperiodicFwdTimeResource-r18 ::= SEQUENCE {
```

| | |
|---|---|
| ncr-AperiodicFwdTimeResourceId-r18 | NCR-AperiodicFwdTimeResourceId-r18, |
| slotOffsetAperiodic-r18 | INTEGER (0..ffs), |
| symbolOffset-r18 | INTEGER (0..maxNrofSymbols−1), |
| durationInSymbols-r18 | INTEGER (1..ffs) |

}
-- TAG-NCR-APEIODICFWDCONFIG-STOP
-- ASN1STOP

That is, information ncr-AperiodicFwdTimeResourceToAddModList-r18 used for adding and/or modifying time domain resources and ncr-AperiodicFwdTimeResourceToReleaseList-r18 (used for released/removed time domain resources) may configure the list of time domain resources. In addition, NCR-AperiodicFwdConfig may include a third parameter referenceSCS-r18, which is used to indicate a reference subcarrier spacing of the aperiodic time domain resource, in other words, all the aperiodic time domain resources use the reference subcarrier spacing.

That the first parameter, the second parameter and the third parameter are respectively used to indicate the reference subcarrier spacings of different types of time domain resources is described above. The first parameter, the second parameter and the third parameter above may indicate multiple identical or different reference subcarrier spacings, and may determine the above second SCS at least based on the first parameter, the second parameter and/or the third parameter.

In the embodiments of this disclosure, “the downlink control information in the first DCI format” or “the downlink control information using the first DCI format” or “the DCI in the first DCI format” may also be directly referred to as “a first DCI format” in brief.

An order of priorities of various types of beam indications is as follows: a semi-persistent beam indication configured with a priority flag>a periodic beam indication configured with a priority flag>an aperiodic beam indication>a semi-persistent beam indication not configured with a priority flag>a periodic beam indication not configured with a priority flag. For a set of symbols (i.e. one or more symbols), when multiple beam indications conflict, the NCR applies a beam index provided by a beam indication which a highest priority (signals are transmitted and received (or forwarded) in the set of symbols (or in the access link)). For example, it may expressed as:

The overall order of priority of different beam indications for access link is defined as: semi-persistent beam
indication with priority flag > periodic beam indication with priority flag > Aperiodic beam indication >
semi-persistent beam indication without priority flag > periodic beam indication without priority flag.
In case of conflict between (two or three) beam indications for a set of symbols, the NCR applies the beam
index provided by the indication with the highest priority for the set of symbols.
The NCR does not expect overlapping time resources provided by either NCR-PeriodicFwdResourceSet or
NCR-SemiPersistentFwdResourceSet to be associated with different beam indexes.

For example, if the first time domain resource provided by the NCR semi-persistent forwarding resource set Semi-PersistentFWdResourceSet is indicated by the MAC CE command and associated with the first beam index, the second time domain resource is provided by the NCR periodic forwarding resource set PeriodicFwdResourceSet and associated with the second beam index, and in the set of symbols, the first time domain resource overlaps with the second time domain resource, if NCR PeriodicFwdResourceSet includes priorityFlag and NCR Semi-PersistentFWdResourceSet does not include priorityFlag, the NCR applies the second beam index to the access link in the set of symbols to transmit and receive signals; otherwise, the NCR applies the first beam index to transmission or reception on the access link in the set of symbols. For example, it may expressed as:

If
- a first time resource provided by NCR-SemiPersistentFwdResourceSet is indicated by a MAC CE
command and is associated with a first beam index, and
- a second time resource is provided by NCR-PeriodicFwdResourceSet and is associated with a second
beam index, and
- the first time resource overlaps with the second time resource in a set of symbols, if NCR-
PeriodicFwdResourceSet includes priorityFlag and NCR-SemiPersistentFwdResourceSet does not include
priorityFlag, the NCR applies the second beam index for transmissions or receptions on the access link in the
set of symbols, otherwise
the NCR applies the first beam index for transmissions or receptions on the access link in the set of symbols.
If
- a first time resource is provided by NCR-PeriodicFwdResourceSet or NCR-
SemiPersistentFwdResourceSet and is associated with a first beam index, and
- a second time resource is indicated by DCI format 2_8 and is associated with a second beam index
provided by the DCI format 2_8, and
- the first time resource overlaps with the second time resource in a set of symbols,
the NCR applies, for transmissions or receptions on the access link in the set of symbols,
- the first beam index if NCR-PeriodicFwdResourceSet or NCR-SemiPersistentFwdResourceSet includes
priorityFlag, and
- the second beam index if NCR-PeriodicFwdResourceSet or NCR-SemiPersistentFwdResourceSet does
not include priorityFlag.

In some embodiments, the NCR does not expect that overlapping time resources provided by NCR PeriodicFwdResourceSet or NCR Semi-PersistentFwdResourceset are associated with different beam indices. The NCR does not expect that overlapping time resources provided by a single first DCI format are associated with different beam indices (for example, if different second information fields in the first DCI format indicate overlapping time domain resources, (the NCR expects that) corresponding first information fields therein (should) indicate an identical beam index). For example, it may be expressed as:

The NCR does not expect overlapping time resources provided by either NCR-PeriodicFwdResourceSet or NCR-
SemiPersistentFwdResourceSet to be associated with different beam indexes.
The NCR does not expect overlapping time resources provided by a single DCI format 2_8 to be associated with
different beam indexes.

In some embodiments, if the NCR receives an indication of a TCI state received on the backhaul link or an indication of a unified TCI state or an SRI for determining a spatial filter transmitted on the backhaul link in the MAC CE command, the NCR applies the MAC CE command from a first one of slots after a slot

$$k + 3 {N}_{slot}^{subframe , μ} ;$$

where, k is a slot on which the NCR-MT will transmit a PUCCH of HARQ-ACK information associated with the PDSCH providing the MAC CE command. For example, it may be expressed as:

```
When the NCR does not simultaneously receive on the control link and the backhaul link
  - if the NCR does not support determination of a TCI state for receptions on the backhaul link based on an
    indication of a TCI state by the serving cell, or if the NCR does not receive or has not applied an
    indication of a TCI state, for receptions on the backhaul link
    - if the NCR does not receive or has not applied an indication of a unified TCI state for receptions by the
        NCR-MT, receptions on the backhaul link use same QCL parameters as the ones for PDCCH
        receptions in a CORESET with the lowest controlResourceSetId in the active DL BWP
    - else, receptions on the backhaul link use the QCL parameters provided by an indicated unified TCI
        state for receptions by the NCR-MT
  - else receptions on the backhaul link use QCL parameters provided by a TCI state in a MAC CE.
  If the NCR receives an indication of a TCI state for receptions on the backhaul link in a MAC CE command,
  $the NCR applies the MAC CE command from the first slot that is after slot k + 3 {N}_{slot}^{subframe , μ} where k is the$
  slot where the NCR-MT would transmit a PUCCH with HARQ-ACK information associated with the PDSCH
  providing the MAC CE command and μ is the SCS configuration for the PUCCH transmission.
When the NCR does not simultaneously transmit on the control link and the backhaul link
  - if the NCR does not support determination of a spatial filter for transmissions on the backhaul link based
    on an indication of a unified TCI state or SRI by the serving cell, or if the NCR-MT does not receive or
    has not applied an indication of a unified TCI state or SRI for determining a spatial filter, for transmissions
    on the backhaul link
    - if the NCR does not receive or has not applied an indication of a unified TCI state for transmissions by
        the NCR-MT, transmissions on the backhaul link use a same spatial filter as the one associated with
        the PUCCH resource with the smallest pucch-ResourceId in PUCCH-ResourceSet in the active UL
        BWP
    - else, transmissions on the backhaul link use a spatial filter corresponding to an indicated unified TCI
        state for transmissions by the NCR-MT.
  - else transmissions on the backhaul link use a spatial filter corresponding to a unified TCI state or SRI
    provided by a MAC CE.
  If the NCR receives an indication of a unified TCI state or SRI for determining a spatial filter for
  transmissions on the backhaul link in a MAC CE command, the NCR applies the MAC CE command from
  $the first slot that is after slot k + 3 {N}_{slot}^{subframe , μ} where k is the slot where the NC \text{R-M} T would transmit a$
  PUCCH with HARQ-ACK information associated with the PDSCH providing the MAC CE command and μ
  is the SCS configuration for the PUCCH transmission.
    or,
When the NCR does not simultaneously receive on the control link and the backhaul link
  - if the NCR does not support determination of a TCI state for receptions on the backhaul link based on an
    indication of a TCI state by the serving cell, or if the NCR does not receive or has not applied an
    indication of a TCI state, for receptions on the backhaul link
    - if the NCR does not receive or has not applied an indication of a unified TCI state for receptions by the
        NCR-MT, receptions on the backhaul link use same QCL parameters as the ones for PDCCH
        receptions in a CORESET with the lowest controlResourceSetId in the active DL BWP
    - else, receptions on the backhaul link use the QCL parameters provided by an indicated unified TCI
        state for receptions by the NCR-MT
  - else receptions on the backhaul link use QCL parameters provided by a TCI state in a MAC CE.
When the NCR does not simultaneously transmit on the control link and the backhaul link
  - if the NCR does not support determination of a spatial filter for transmissions on the backhaul link based
    on an indication of a unified TCI state or SRI by the serving cell, or if the NCR-MT does not receive or
    has not applied an indication of a unified TCI state or SRI for determining a spatial filter, for transmissions
    on the backhaul link
    - if the NCR does not receive or has not applied an indication of a unified TCI state for transmissions by
        the NCR-MT, transmissions on the backhaul link use a same spatial filter as the one associated with
        the PUCCH resource with the smallest pucch-ResourceId in PUCCH-ResourceSet in the active UL
        BWP
    - else, transmissions on the backhaul link use a spatial filter corresponding to an indicated unified TCI
        state for transmissions by the NCR-MT.
  - else transmissions on the backhaul link use a spatial filter corresponding to a unified TCI state or SRI
    provided by a MAC CE.
  If the NCR receives an indication of a TCI state for receptions on the backhaul link or an indication of a
  unified TCI state or SRI for determining a spatial filter for transmissions on the backhaul link in a MAC CE
  command, the NCR applies the MAC CE command from the first slot that is after slot k +
  $3 {N}_{slot}^{subframe , μ} where k is the slot where the NC \text{R-M} T would transmit a PUCCH with HAR \text{Q-A} CK$
  information associated with the PDSCH providing the MAC CE command and μ is the SCS
  configuration for the PUCCH transmission.
```

It was found by the inventor that for an ordinary UE, the first timing may possibly be “invalidated” in some cases (the UE is unable to transmit uplink signals by using the first timing). For the NCR, if the NCR-Fwd needs to use the first timing for forwarding, impact of such a possibility on the NCR needs to taken into account, so as to ensure forwarding performances of the NCR.

The embodiments of this disclosure provide a signal forwarding method, which shall be described from a repeater side.

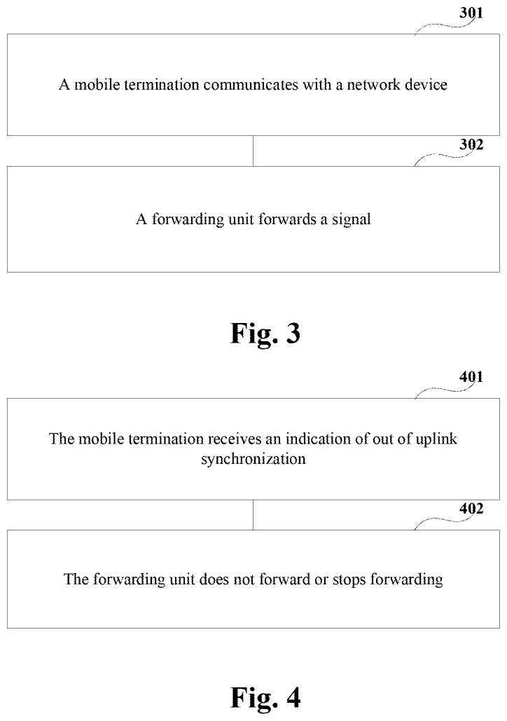

FIG. 3 is a schematic diagram of the signal forwarding method of the embodiments of this disclosure. As shown in FIG. 3, the method includes:
301: a mobile termination communicates with a network device; and
302: a forwarding unit forwards a signal.

In some embodiments, when a time alignment timer expires,
the forwarding unit forwards or does not forward or stops forwarding, and/or,
the mobile termination determines that a radio link failure (RLF) is detected, and/or,
the mobile termination initiates radio resource control (RRC) connection reestablishment, and/or,
the mobile termination initiates a random access procedure, and/or,
a lower layer of the mobile termination transmits an indication of expiration of the time alignment timer and/or RLF and/or a problem of time alignment to a higher layer, and/or,
the mobile termination enters an RRC idle state.

In some embodiments, for the NCR/NCR-MT, the network device may configure a fourth parameter/a timer for the NCR (via RRC signaling) to maintain uplink time alignment/calibration/matching (UL time alignment). For example, the fourth parameter/timer includes an alignment timer timeAlignmentTimer (per TAG), which controls (the MAC entity of) the NCR-MT to declare how long an uplink time of a serving cell in a TAG associated with the alignment timer is aligned/calibrated/matched. The alignment timer corresponds to the NCR-MT, and when the alignment timer expires, (the MAC entity declares that) the uplink time of the serving cell in the TAG associated with the alignment timer is not aligned/calibrated/matched. The fourth parameter may be carried by SIB1 and/or dedicated RRC signaling.

Furthermore, the network device may configure a fifth parameter/timer for the NCR (via RRC signaling), the fifth parameter/timer including inactivePosSRS-TimeAlignmentTimer, which controls the MAC entity of the NCR-MT to determine how long an uplink time of positioning SRS transmission is aligned/calibrated/matched in the RRC inactive state.

Furthermore, the network device may configure a sixth parameter for the NCR (via RRC signaling), the sixth parameter including cg-SDT-TimeAlignmentTimer, which controls the MAC entity of the NCR-MT to declare how long an uplink time of uplink transmission of CG-SDT (small data transmission) is aligned/calibrated/matched. When the timer expires, the CG resources are released, but the CG resource configuration is maintained.

In some embodiments, for the TAG, it is a group of serving cells configured by RRC or includes a group of serving cells configured by RRC. For a cell configured with UL (carrier), identical timing reference cells and identical timing advance values are used. A timing advance group of an SpCell including an MAC entity is referred to as a primary timing advance group (PTAG), and an STAG (secondary TAG) refers to another TAG. The serving cell of the NCR-MT includes only a Pcell, and at this time, there is only a PTAG, and the PTAG only includes a Pcell. The TAG has a TAG identifier 0. Or, the serving cell of the NCR-MT includes a Pcell and Scell(s), wherein the Scell(s) include(s) a PScell and/or other Scell(s), and at this time, there may possibly exist one or more TAG(s), such as one PTAG, and one STAG; however, it is not limited thereto.

In some embodiments, if the serving cell of the NCR-MT has only a Pcell, RRC will configure timeAlignmentTimer for the PTAG/associated with the PTAG.

For example, if the time alignment timer expires (and the NCR-MT is in an RRC_CONNECTED state), the NCR-Fwd stops forwarding/does not forward.

For example, if the time alignment timer expires (and the NCR-MT is in an RRC_CONNECTED state), the NCR-MT determines (declares/assumes) that an RLF is detected.

For example, if the time alignment timer expires (and the NCR-MT is in the RRC_CONNECTED state), the NCR-MT initiates RRC connection reestablishment, such as initiating by the MAC entity itself or by RRC.

For example, if the time alignment timer expires (and the NCR-MT is in the RRC_CONNECTED state), the NCR-MT initiates a random access procedure on the SpCell, including contention-free random access (CFRA RACH) or contention-based random access (CBRA RACH).

For example, if the time alignment timer expires (and the NCR-MT is in the RRC_CONNECTED state), the NCR-MT initiates a random access procedure on the SpCell, including contention-free random access (CFRA RACH) or contention-based random access (CBRA RACH).

The random access procedure may be a 4-step RA type or a 2-step RA type. The two RA types include CBRA and CFRA, respectively. In some cases, the 2-step RA type may be back off or switched to the 4-step RA type.

The contention-based random access with 4-step RA type (CBRA with 4-step RA type, or 4-step CBRA) needs at least 4 steps, which may also be referred to as 4-step random access (4-step RA or 4-step RACH). The 4-step random access includes two times of information exchange between the network device and the terminal equipment. In Msg1 (or MSG1), the terminal equipment transmits a random access preamble or a PRACH, and after transmitting Msg1, the terminal equipment monitors a response (random access response, RAR) from the network device in a window (e.g. an RAR window). In Msg2 (or MSG2), the network device transmits a random access response. In Msg3 (or MSG3), the terminal equipment transmits an uplink message on an allocated uplink resource (or, in other words, transmits Msg3 or an MSG3 PUSCH by using an uplink grant (UL grant) scheduled in the random access response). In Msg4 (or MSG4), the network device feeds a contention resolution message back to the terminal equipment that has successfully accessed. If the terminal equipment does not receive Msg2 or a corresponding RAR after transmitting Msg1, or if contention resolution fails after transmission or retransmission of Msg3, the UE turns back to Msg1 transmission.

The contention-free random access with 4-step RA type (CFRA with 4-step RA type) at least needs 2 or 3 steps (depending on whether Msg0 is taken into account), wherein in Msg0 (MSG0), the network device allocates dedicated random access preambles and/or PRACH resources to the terminal equipment, and in Msg1 (or MSG1), the terminal equipment transmits a random access preamble or PRACH, and after transmitting Msg1, the terminal equipment monitors a response (random access response, RAR) from the network device in a window (e.g. an RAR window). In Msg2 (or MSG2), the network device transmits a random access response. The random access procedure comes to an end when the terminal equipment receives the random access response.

For the 2-step RA type, in MsgA (or MSGA), the terminal equipment transmits a random access preamble (PRACH) and an MSGA PUSCH, and in MSGB, the network device transmits a random access response.

For example, the NCR-MT initiates random access for at least one of the following:
initial access from the RRC IDLE state;
the RRC connection reestablishment procedure;
during the RRC_CONNECTED or an RRC_INACTIVE state (SDT procedure is ongoing), DL/UL data arrival, and an uplink synchronization state is “non-synchronised”;
during the RRC_CONNECTED or the RRC_INACTIVE state (SDT procedure is ongoing), UL data arrival, and there are no PUCCH resources for SR available;
SR failure;
synchronous reconfiguration (e.g. handover) triggered/requested by RRC;
an RRC connection Resume procedure from the RRC_INACTIVE state;
Request for Other SI;
beam failure recovery;
Consistent UL LBT failure on SpCell
SDT in the RRC_INACTIVE state;
positioning during the RRC_CONNECTED state (e.g. when TA is needed for positioning); and
Expiration of the time alignment timer for an NCR-MT.

For example, it may be expressed as:

| | The random access procedure is triggered by a number of events: | |
|---|---|---|
| | - | Initial access from RRC_IDLE; |
| | - | RRC Connection Re-establishment procedure; |
| | - | DL or UL data arrival, during RRC_CONNECTED or during RRC_INACTIVE while SDT procedure |
| | | is ongoing, when UL synchronisation status is “non-synchronised”; |
| | - | UL data arrival, during RRC_CONNECTED or during RRC_INACTIVE while SDT procedure is |
| | | ongoing, when there are no PUCCH resources for SR available; |
| | - | SR failure; |
| | - | Request by RRC upon synchronous reconfiguration (e.g. handover); |
| | - | RRC Connection Resume procedure from RRC_INACTIVE; |
| | - | To establish time alignment for a secondary TAG; |
| | - | Request for Other SI; |
| | - | Beam failure recovery; |
| | - | Consistent UL LBT failure on SpCell; |
| | - | SDT in RRC_INACTIVE; |
| | - | Positioning purpose during RRC_CONNECTED requiring random access procedure, e.g., when timing |
| | | advance is needed for UE positioning. |
| | - | Expiration of the time alignment timer for an NCR-MT. |
| 1> | when a timeAlignmentTimer expires: | |
| | 2> | if the timeAlignmentTimer is associated with the PTAG: |

| | |
|---|---|
| 3> | flush all HARQ buffers for all Serving Cells; |
| 3> | notify RRC to release PUCCH for all Serving Cells, if configured; |
| 3> | notify RRC to release SRS for all Serving Cells, if configured; |
| 3> | clear any configured downlink assignments and configured uplink grants; |
| 3> | clear any PUSCH resource for semi-persistent CSI reporting; |
| 3> | consider all running timeAlignmentTimers as expired; |
| 3> | maintain N_{TA} of all TAGS. |
| 3> | if the timeAlignmentTimer is for an NCR-MT, |
| | 4> indicate to NCR-Fwd to cease forwarding. |

| | |
|---|---|
| 4> | initiate a Random Access Procedure on SpCell.2> else if the timeAlignmentTimer is associated with |
| | an STAG, then for all Serving Cells belonging to this TAG: |

| | |
|---|---|
| 3> | flush all HARQ buffers; |
| 3> | notify RRC to release PUCCH, if configured; |
| 3> | notify RRC to release SRS, if configured; |
| 3> | clear any configured downlink assignments and configured uplink grants; |
| 3> | clear any PUSCH resource for semi-persistent CSI reporting; |
| 3> | maintain N_{TA} of this TAG. |

For example, if the time alignment timer expires (and the NCR-MT is in the RRC_CONNECTED state), a lower layer of the NCR-MT (such as an MAC layer (MAC entity)) transmits an indication of expiration of the time alignment timer and/or an RLF and/or a problem of time alignment to a higher layer (such as an RRC layer). (If) The higher layer of the NCR-MT (e.g. an RRC layer) receives the indication of expiration of the time alignment timer and/or the RLF from the lower layer (e.g. an MAC layer (MAC entity)), the higher layer of the NCR-MT declares that an RLF is detected, and/or initiates RRC connection reestablishment, and/or triggers the lower layer to initiate a random access procedure, and/or initiates a random access procedure.

For example, when the time alignment timer expires (and the NCR-MT is in the RRC_CONNECTED state), the NCR-MT enters an RRC IDLE state.

In some embodiments, that the uplink synchronization state is ‘non-synchronised’ refers to that the time alignment timer has expired; however, it is not limited thereto.

The above examples may be implemented separately or in a combined manner, and the embodiments of this disclosure is not limited thereto.

In some embodiments, the mobile termination transmits a cause of RRC connection reestablishment and/or a cause of a radio link failure, the cause(s) including expiration of the time alignment timer or a problem of time alignment or other causes of failures. For example, if the NCR-MT declares an RLF due to an indication of random access problem and/or an indication of expiration of the time alignment timer and/or an RLF and/or a problem of time alignment from the lower layer, and/or if the random access procedure is initiated for the expiration of the time alignment timer and/or the problem of time alignment, the NCR-MT sets the cause of RRC connection reestablishment reestablishmentCause or the cause of radio link failure rlf-Cause to be expiration of the time alignment timer or a problem of time alignment or otherFailure, and carry the cause in, for example, an RRCReestainmentRequest message (in Msg3), and transmits it to the network device.

In some embodiments, when the time alignment timer expires and the mobile termination is in the RRC connected state or the RRC inactive state, the forwarding unit performs forwarding. In order to support that the NCR-Fwd of NCR may perform forwarding when the NCR-MT is in the RRC_INACTIVE state, when the mobile termination is transferred into the RRC inactive state and the time alignment timer is declared expired, the forwarding unit performs forwarding according to the configured periodic forwarding resources. For example, (if) timeAlignmentTimer is declared expired due to that the NCR-MT enters the RRC_INACTIVE state, and if the NCR forwarding configuration includes the periodic forwarding resource, the NCR-Fwd proceeds with forwarding (only) according to the configured periodic forwarding resource (when the NCR-MT is in the RRC_INACTIVE state), even if there are semi-persistent and/or aperiodic resource configuration, it will perform forwarding (only) according to the configured periodic forwarding resource. Or, when the mobile termination is transferred to the RRC inactive state, the time alignment timer is not declared expired and/or the time alignment timer is stopped. For example, if the NCR-MT enters the RRC_INACTIVE and the NCR forwarding configuration includes the periodic forwarding resources, timeAlignmentTimer is not declared expired and/or the time alignment timer is stopped. How to configure the periodic forwarding resource is as described above, and shall not be repeated herein any further.

In some embodiments, when the mobile termination is transferred to the RRC inactive state and the time alignment timer is not declared expired and/or the time alignment timer is stopped, the forwarding unit performs forwarding according to the configured periodic forwarding resource. In some embodiments, the NCR/NCR-MT/NCR-Fwd expect(s) that a value of the time alignment timer (configured for the PTAG (in SIB1 and/or dedicated RRC signaling)) is configured to be ‘infinity’ (i.e., never expires). That is, for the NCR/NCR-MT/NCR-Fwd, RRC always configures the value of the time alignment timer to be “infinity”.

In some embodiments, the NCR/NCR-MT/NCR-Fwd ignore(s) the value of the time alignment timer configured (in SIB1 and/or dedicated RRC signaling)), and/or, the value of the time alignment timer is “infinity” by default ((if) the value of the time alignment timer configured in SIB 1 is not “infinite” and/or the dedicated RRC signaling does not configure a value of the time alignment timer.

The embodiments of this disclosure provide a signal forwarding method, which shall be described from a repeater side.

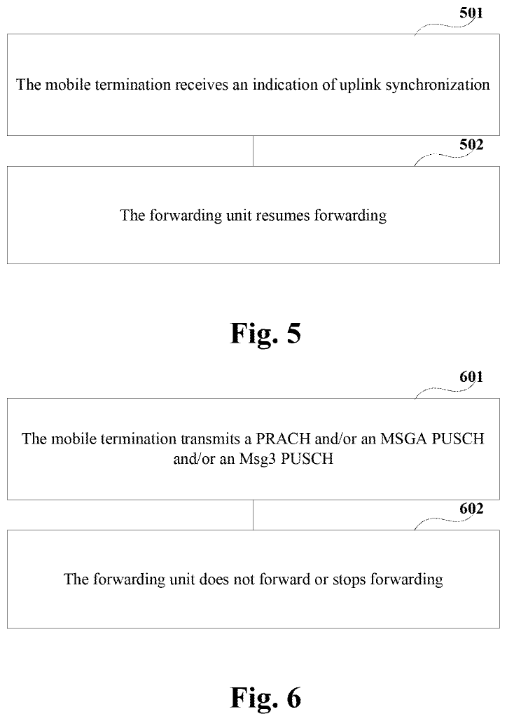

FIGS. 4 and 5 are schematic diagrams of the signal forwarding method of the embodiments of this disclosure. As shown in FIGS. 4 and 5, the method includes:
401: the mobile termination receives an indication of out of uplink synchronization;
402: the forwarding unit does not forward or stops forwarding; and/or
501: the mobile termination receives an indication of uplink synchronization; and
502: the forwarding unit resumes forwarding.

In some embodiments, the receiving an indication of out of uplink synchronization includes that a lower layer of the mobile termination receives an indication of out of uplink synchronization transmitted by a higher layer. For example, when T430 expires, the higher layer (RRC layer) indicates out of uplink synchronization to the lower layer (MAC layer); however, it is not limited thereto.

The receiving an indication of uplink synchronization includes that the lower layer of the mobile termination receives an indication of uplink synchronization transmitted by the higher layer, and receiving an indication of uplink synchronization indicates obtaining/resuming uplink synchronization.

For example, it may be expressed as:

The MAC entity shall for each Serving Cell:

| | |
|---|---|
| 1> | if an indication of uplink synchronization has been received from upper layers: |
| | 2> allow uplink transmission on the Serving Cell. |
| | 2> if the indication of uplink synchronization is for an NCR-MT, |
| | 3> indicate to NCR-Fwd to resume forwarding. |
| 1> | if an indication of uplink synchronization loss is received from upper layers : |
| | 2> flush all HARQ buffers; |
| | 2> not perform any uplink transmission on the Serving Cell. |
| | 2> if the indication of uplink synchronization loss is for an NCR-MT, |
| | 3> indicate to NCR-Fwd to cease forwarding. |

NOTE:
The MAC entity suspends all UL operations (e.g. stop RACH, SR, and UL HARQ operation) after receiving the indication of an uplink synchronization loss and resumes the operation when receiving an indication of uplink synchronization.

Currently, for the NCR, a gNB cell forwarded by the NCR-Fwd is identical to a cell to which the NCR-MT is connected. Whether the NCR-Fwd may forward other cells is dependent on implementations. In the cell to which the NCR-MT is connected, the NCR-MT will share at least identical PRACH occasion and MsgA-PUSCH occasion configured in SIB1 with a serving UE served by the NCR-Fwd. In order to support random access of the UE, the gNB will configure/indicate that the NCR-Fwd may forward (ON) in a scenario of PRACH/MsgA-PUSCH by configuring/indicating corresponding beams of the NCR-Fwd. In addition, for Mg3-PUSCH in the 4-step CBRA, as the gNB is unable to recognize whether the NCR-MT or a normal UE performs random access, the gNB may indicate that the NCR-Fwd may forward (ON) on time resources scheduling Msg3-PUSCH. In order to support random access of the UE served by the NCR-Fwd, the gNB may configure/indicate that the NCR-Fwd forwards on a configured PRACH/MsgA occasion and a scheduled Msg3 PUSCH.

It was found by the inventor that when the NCR-MT is transmitting a PRACH/MsgA PUSCH, it uses the second timing. However, as described in the above embodiments, the NCRFwd uses the first timing for transmission in the BH link. Hence, as the times of the NCR-MT are inconsistent, the NCR-Fwd should stop forwarding/not forward (off). It should be noted that the random access of the NCR-MT should have a priority higher than that of the forwarding of the NCR-Fwd. In addition, according to capabilities, the NCR may possibly not support simultaneous UL transmission of the control link and the BH link. For the NCR unable to simultaneously perform UL transmission on both the control link and the BH link, when the NCR-MT is transmitting a PRACH or PUSCH MsgA or Msg3, the NCR-Fwd should stop forwarding/not forward (off).

Therefore, the embodiments of this disclosure provide a signal forwarding method, which shall be described from a repeater side.

FIG. 6 is a schematic diagram of the signal forwarding method of the embodiments of this disclosure. As shown in FIG. 6, the method includes:
601: the mobile termination transmits a PRACH and/or an MSGA PUSCH and/or an Msg3 PUSCH; and
602: the forwarding unit does not forward or stops forwarding.

In some embodiments, the forwarding unit does not forward or stops forwarding when the mobile termination transmits a PRACH and/or an MSGA PUSCH and/or an Msg3 PUSCH.

It was further found by the inventor that the random access procedure of the NCR-MT is triggered due to the necessity of (re) configuration of the NCR. Specific triggered scenarios are as described above, and shall not be repeated herein any further. In some scenarios (such as when an uplink synchronization state is “non-synchronised”), there exists a problem in the performance of forwarding (if any) of the NCR-Fwd. Hence, the NCR-Fwd should not forward within the duration of the random access procedure. Therefore, the embodiments of this disclosure provide a signal forwarding method, which shall be described from a repeater side.

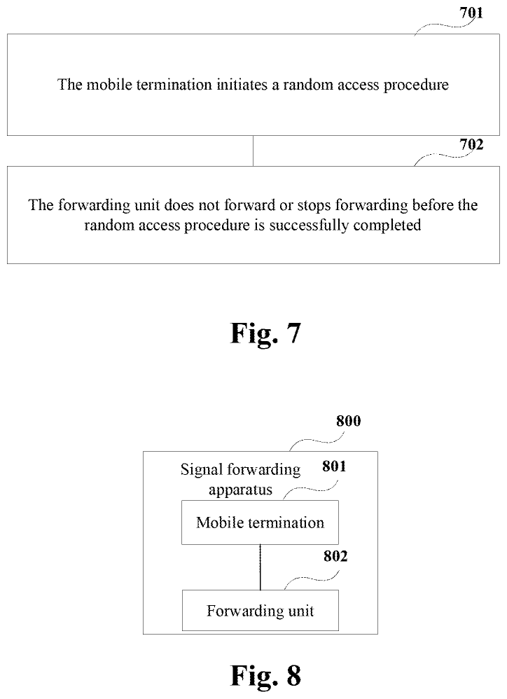

FIG. 7 is a schematic diagram of the signal forwarding method of the embodiments of this disclosure. As shown in FIG. 7, the method includes:
701: the mobile termination initiates a random access procedure; and
702: the forwarding unit does not forward or stops forwarding until the random access procedure is successfully completed.

That is, if the random access is initiated by the NCR-MT, it is indicated that the NCR-Fwd stops forwarding/does not forward. For example, it may expressed as:

When the Random Access procedure is initiated on a Serving Cell, the MAC entity shall:
1> flush the Msg3 buffer;
flush the MSGA buffer;
if the Random access is initiated for an NCR-MT,
2> indicate to NCR-Fwd to cease forwarding.
set the PREAMBLE_TRANSMISSION_COUNTER to 1;
....

In the above embodiment, the NCR-Fwd does not forward/stops forwarding, that is, the NCR-Fwd is in an offstate (a transmitter is off, and it unable to perform forwarding behaviors).

### Embodiments of a Second Aspect

The embodiments of this disclosure provide a signal forwarding apparatus. The signal forwarding apparatus may be a repeater, or may be applicable to a repeater, for example, it may be the NCR as described above, or may a network device or a terminal equipment having a function of forwarding, or one or some components or assemblies configured in the NCR or the network device or the terminal equipment.

FIG. 8 is a schematic diagram of the signal forwarding apparatus of the embodiments of this disclosure. As a principle of the signal forwarding apparatus for solving problems is similar to that of the method in the embodiments of the first aspect, reference may be made to the embodiments of the first aspect for implementation of the apparatus, with identical contents being not going to be described herein any further.

As shown in FIG. 8, the signal forwarding apparatus 800 of the embodiments of this disclosure includes a mobile termination 801 and a forwarding unit 802, both of which being functional entities, and functions thereof being able to be implemented by identical or different hardware modules.

Reference may be to the embodiments of the first aspect for implementations of the mobile termination 801 and the forwarding unit 802, which shall not be repeated herein any further.

Furthermore, for the sake of simplicity, connection relationships between the components or modules or signal profiles thereof are only illustrated in FIG. 8. However, it should be understood by those skilled in the art that such related techniques as bus connection, etc., may be adopted. And the above components or modules may be implemented by hardware, such as a processor, a memory, a transmitter, and a receiver, etc., which are not limited in the embodiments of this disclosure.

The above implementations only illustrate the embodiments of this disclosure. However, this disclosure is not limited thereto, and appropriate variants may be made on the basis of these implementations. For example, the above implementations may be executed separately, or one or more of them may be executed in a combined manner.

### Embodiments of a Third Aspect

The embodiments of this disclosure provide an information transmission method, which shall be described from a network device side, with contents identical to those in the embodiments of the first aspect being not going to be described herein any further.

The embodiments of this disclosure further provide an information transmission method, including: transmitting a timing advance command to an NCR, the timing advance command indicating an index value T_{A} for controlling a first timing; and receiving a signal transmitted by the NCR on a backhaul link by using the first timing. Reference may be made to the embodiments of the first aspect for implementations of the above features, which shall not be described herein any further.

The steps or processes related to this disclosure are only described above; however, this disclosure is not limited thereto. The method of the embodiments of this disclosure may also include other steps or processes, and reference may be made to relevant techniques for specific contents of these steps or processes.

The above implementations only illustrate the embodiments of this disclosure. However, this disclosure is not limited thereto, and appropriate variants may be made on the basis of these implementations. For example, the above implementations may be executed separately, or one or more of them may be executed in a combined manner.

### Embodiments of a Fourth Aspect

The embodiments of this disclosure provide an information transmission apparatus.

FIG. 10 is a schematic diagram of the information transmission apparatus of the embodiments of this disclosure. As a principle of the information transmission apparatus for solving problems is similar to that of the method in the embodiments of the third aspect, reference may be made to the embodiments of the third aspect for implementation of the apparatus, with identical contents being not going to be described herein any further.

As shown in FIG. 10, the information transmission apparatus 1000 of the embodiments of this disclosure include:
a transmitter 1001 configured to transmit a timing advance command to an NCR, the timing advance command indicating an index value T_{A} for controlling a first timing; and
a receiver 1002 configured to receive signals transmitted by the NCR on a backhaul link by using the first timing.

Reference may be made to the embodiments of the first aspect for implementations of the above features, which shall not be described herein any further.

It should be noted that the components or modules related to this disclosure are only described above. However, this disclosure is not limited thereto, and the information transmission apparatus 1000 of the embodiments of this disclosure may further include other components or modules, and reference may be made to related techniques for particulars of these components or modules.

Furthermore, for the sake of simplicity, connection relationships between the components or modules or signal profiles thereof are only illustrated in FIG. 10. However, it should be understood by those skilled in the art that such related techniques as bus connection, etc., may be adopted. And the above components or modules may be implemented by hardware, such as a processor, a memory, a transmitter, and a receiver, etc., which are not limited in the embodiments of this disclosure.

The above implementations only illustrate the embodiments of this disclosure. However, this disclosure is not limited thereto, and appropriate variants may be made on the basis of these implementations. For example, the above implementations may be executed separately, or one or more of them may be executed in a combined manner.

### Embodiments of a Fifth Aspect

The embodiments of this disclosure provide a communication system. FIG. 1 is a schematic diagram of the communication system of the embodiments of this disclosure. As shown in FIG. 1, the communication system includes a network device 101, a repeater 102 and a terminal equipment 103. For the sake of simplicity, description is given in FIG. 1 by taking one network device, one repeater and one terminal equipment only as an example; however, the embodiments of this disclosure are not limited thereto.

In the embodiments of this disclosure, existing traffics or traffics that may be implemented in the future may be performed between the network device 101 and the terminal equipment 103. For example, such traffics may include but not limited to enhanced mobile broadband (eMBB), massive machine type communication (mMTC), ultra-reliable and low-latency communication (URLLC), and vehicle to everything (V2X) communication, etc. The repeater 102 is configured to execute the signal forwarding method in the embodiments of the first aspect, and the network device 101 is configured to execute the information transmission method in the embodiments of the third aspect, contents of which being incorporated herein, which shall not be repeated herein any further.

The embodiments of this disclosure further provide an electronic device, which may be, for example, a repeater or a network device.

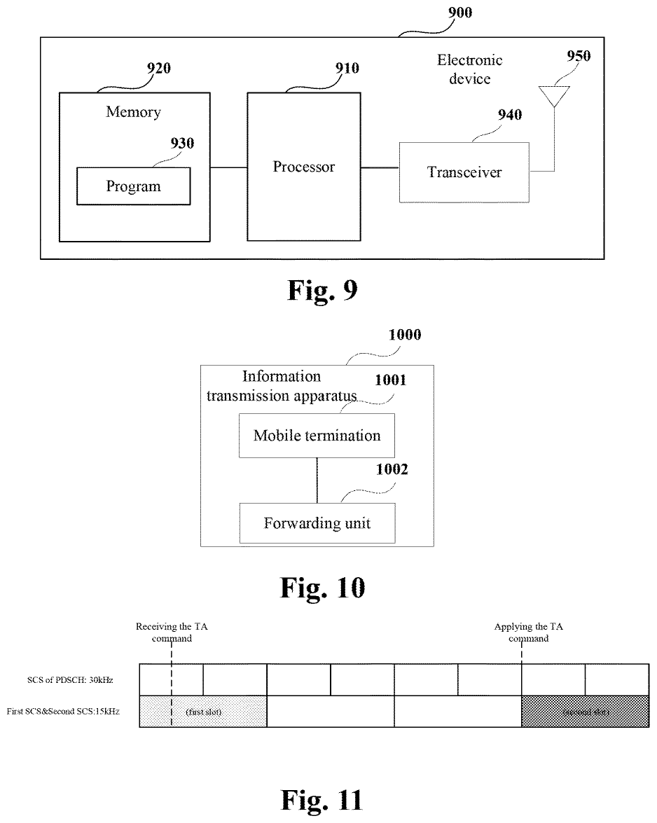

FIG. 9 is a schematic diagram of a structure of the electronic device of the embodiments of this disclosure. As shown in FIG. 9, the electronic device 900 may include a processor 910 (such as a central processing unit (CPU)) and a memory 920, the memory 920 being coupled to the processor 910. Wherein, the memory 920 may store various data, and furthermore, it may store a program 930 for information processing, and execute the program 930 under control of the processor 910.

For example, the processor 910 may be configured to execute a program to execute the method described in the embodiments of the first or the third aspect.

Furthermore, as shown in FIG. 9, the electronic device 900 may include a transceiver 940, and an antenna 950, etc. Wherein, functions of the above components are similar to those in the related art, and shall not be described herein any further. It should be noted that the electronic device 900 does not necessarily include all the parts shown in FIG. 9, and furthermore, the electronic device 900 may include parts not shown in FIG. 9, and the related art may be referred to.

An embodiments of this disclosure provide a computer program, which, when executed in a repeater or a network device, will cause a computer to carry out the method described in the embodiments of the first or the third aspect in the repeater or the network device.

An embodiments of this disclosure provide a storage medium, including a computer program, which will cause a computer to carry out the method described in the embodiments of the first or the third aspect in a repeater or a network device.

The above apparatuses and methods of this disclosure may be implemented by hardware, or by hardware in combination with software. This disclosure relates to such a computer-readable program that when the program is executed by a logic device, the logic device is enabled to carry out the apparatus or components as described above, or to carry out the methods or steps as described above. This disclosure also relates to a storage medium for storing the above program, such as a hard disk, a floppy disk, a CD, a DVD, and a flash memory, etc.

The methods/apparatuses described with reference to the embodiments of this disclosure may be directly embodied as hardware, software modules executed by a processor, or a combination thereof. For example, one or more functional block diagrams and/or one or more combinations of the functional block diagrams shown in the drawings may either correspond to software modules of procedures of a computer program, or correspond to hardware modules. Such software modules may respectively correspond to the steps shown in the drawings. And the hardware module, for example, may be carried out by firming the soft modules by using a field programmable gate array (FPGA).

The soft modules may be located in an RAM, a flash memory, an ROM, an EPROM, and EEPROM, a register, a hard disc, a floppy disc, a CD-ROM, or any memory medium in other forms known in the art. A memory medium may be coupled to a processor, so that the processor may be able to read information from the memory medium, and write information into the memory medium; or the memory medium may be a component of the processor. The processor and the memory medium may be located in an ASIC. The soft modules may be stored in a memory of a mobile termination, and may also be stored in a memory card of a pluggable mobile termination. For example, if equipment (such as a mobile termination) employs an MEGA-SIM card of a relatively large capacity or a flash memory device of a large capacity, the soft modules may be stored in the MEGA-SIM card or the flash memory device of a large capacity.

One or more functional blocks and/or one or more combinations of the functional blocks in the drawings may be realized as a universal processor, a digital signal processor (DSP), an application-specific integrated circuit (ASIC), a field programmable gate array (FPGA) or other programmable logic devices, discrete gate or transistor logic devices, discrete hardware component or any appropriate combinations thereof carrying out the functions described in this application. And the one or more functional block diagrams and/or one or more combinations of the functional block diagrams in the drawings may also be realized as a combination of computing equipment, such as a combination of a DSP and a microprocessor, multiple processors, one or more microprocessors in communication combination with a DSP, or any other such configuration.

This disclosure is described above with reference to particular embodiments. However, it should be understood by those skilled in the art that such a description is illustrative only, and not intended to limit the protection scope of the present disclosure. Various variants and modifications may be made by those skilled in the art according to the spirits and principle of the present disclosure, and such variants and modifications fall within the scope of the present disclosure.

The embodiments of this disclosure include the following supplements.

1. A signal forwarding apparatus, applicable to a repeater, including:
a mobile termination configured to communicate with a network; and
a forwarding unit configured to forward a signal,
wherein when a time alignment timer expires,
the forwarding unit performs forwarding or does not perform forwarding or stops forwarding, and/or
the mobile termination determines that a radio link failure (RLF) is detected, and/or
the mobile termination initiates radio resource control (RRC) connection reestablishment, and/or
the mobile termination initiates a random access procedure, and/or
a lower layer of the mobile termination transmits an indication of expiration of the time alignment timer and/or an RLF and/or a problem of time alignment to a higher layer, and/or
the mobile termination enters an RRC idle state.

2. The apparatus according to supplement 1, wherein when the time alignment timer expires, the mobile termination is in an RRC connected state; or, when the time alignment timer expires, the mobile termination is in an RRC connected or an RRC inactive state, and the forwarding unit performs forwarding.

3. The apparatus according to supplement 1, wherein when the higher layer (RRC layer) of the mobile termination receives the indication of the MAC layer, the higher layer (RRC layer) determines that an RLF is detected, and/or initiates RRC connection reestablishment, and/or triggers a lower layer (the MAC layer) to initiate a random access procedure, and/or initiates a random access procedure.

4. The apparatus according to supplement 1 or 3, wherein the mobile termination transmits a cause of RRC connection reestablishment and/or a cause of a radio link failure, the cause(s) including expiration of the time alignment timer or a problem of time alignment or other cause(s) of failures.

5. The apparatus according to supplement 1, wherein when the mobile termination is transferred into an RRC inactive state and the time alignment timer is declared expired, the forwarding unit performs forwarding according to a configured periodic forwarding resource; or, when the mobile termination is transferred to an RRC inactive state and the time alignment timer is not declared expired and/or the time alignment timer is stopped, the forwarding unit performs forwarding according to a configured periodic forwarding resource.

6. The apparatus according to supplement 1, wherein when the mobile termination is transferred to an RRC inactive state, the time alignment timer is not declared expired and/or the time alignment timer is stopped.

7. A signal forwarding apparatus, applicable to a repeater, including:
a mobile termination configured to receive an indication of out of uplink synchronization; and
a forwarding unit configured to not to forward or stop forwarding; and/or
a mobile termination configured to receive an indication of uplink synchronization; and
a forwarding unit configured to resume forwarding.

8. The apparatus according to supplement 7, wherein the receiving an indication of out of uplink synchronization includes that a lower layer of the mobile termination receives an indication of out of uplink synchronization transmitted by a higher layer;

and the receiving an indication of uplink synchronization includes that a lower layer of the mobile termination receives an indication of uplink synchronization transmitted by a higher layer.

9. A signal forwarding apparatus, applicable to a repeater, including:
a mobile termination configured to transmit a PRACH and/or an MSGA PUSCH and/or an Msg3 PUSCH; and
a forwarding unit configured to not to forward or stop forwarding; and/or a mobile termination configured to initiate a random access procedure; and
a forwarding unit configured to not to forward or stop forwarding before the random access procedure is successfully completed.

10. A signal transmission apparatus, applicable to a network device, including:
a first transmitting unit configured to transmit a timing advance command to an NCR, the timing advance command indicating an index value T_{A} used to control a first timing; and
a first receiving unit configured to receive a signal transmitted by the NCR on a backhaul link by using the first timing.

1. A signal forwarding apparatus, applicable to a repeater, the apparatus comprising:
a mobile termination (MT) configured to receive a timing advance command, the timing advance command indicating an index value T_{A} for controlling a first timing; and
a forwarding entity configured to transmit a signal on a backhaul link by using the first timing, wherein
the repeater is an RF repeater,
the mobile termination is used to communicate with a network device via a control link, and
the forwarding entity is used to forward an RF signal between a network device and a user equipment via the backhaul link and an access link.

2. The apparatus according to claim 1, wherein the repeater is an NCR (network controlled repeater), and the mobile termination is an NCR-MT, and the forwarding entity is an NCR-Fwd.

3. The apparatus according to claim 1, wherein, when the repeater receives an indication of a TCI (transmission configuration indicator) state for receptions on the backhaul link in a MAC (media access control) CE (control element) command, or an indication of a unified TCI state or of an SRI (SRS resource indicator or SRS resource ID) for determining a spatial filter for transmissions on the backhaul link in a MAC CE command, the repeater applies the MAC CE command from a first one of slots that is after slot
$$k + 3 \cdot {N}_{slot}^{subframe , μ} ,$$
where k is a slot where the mobile termination would transmit a PUCCH (physical uplink control channel) with HARQ-ACK (hybrid automatic repeat request-acknowledgement) information associated with a PDSCH (physical downlink shared channel) providing the MAC CE command,
$${N}_{slot}^{subframe , μ}$$
is the number of slots per subframe for a SCS (subcarrier spacing) configuration μ of a PUCCH transmission.

4. The apparatus according to claim 1, wherein in a case that a first time resource provided by a first parameter for configuring a semi-persistent forwarding resource set is indicated by a MAC CE command and is associated with a first beam index, a second time resource is provided by a second parameter for configuring a periodic forwarding resource set and is associated with a second beam index, and the first time resource overlaps with the second time resource in a set of symbols, and when
the second parameter comprises a priority flag and the first parameter does not comprise a priority flag,
the repeater applies the second beam index for transmissions or receptions on the access link in the set of symbols, otherwise the repeater applies the first beam index for transmissions or receptions on the access link in the set of symbols.

5. The apparatus according to claim 1, wherein, the mobile termination receives a DCI (downlink control information) indicating a time resource and a corresponding beam index of the access link, and,
when the DCI indicates overlapped time resources, the repeater expects that beam indexes associated with the overlapped time resources have a same value.

6. The apparatus according to claim 1, wherein, the mobile termination is configured to monitor a PDCCH (physical downlink control channel) according to USS (UE-specific search space) sets for detection of a DCI with CRC (cyclic redundancy check) scrambled by a RNTI (radio network temporary identifier) dedicated to the repeater;
a time resource and a corresponding beam index for transmissions or receptions on the access link are indicated by corresponding fields in the DCI;
when the repeater detects more than one DCI that indicates beam index(es) for time resource(s) overlapping in a set of symbols, the repeater uses for the set of symbols a beam index that is indicated by a DCI that the mobile termination detects in a most recent PDCCH monitoring occasion, the time resource starts at a slot that is offset by a number of slots from a reference slot and at a symbol that is offset by a number of symbols from the start of the slot, and has a duration provided by a third parameter for configuring duration in symbols for a SCS provided by a fourth parameter in a fifth parameter for aperiodic forwarding configuration; and
the reference slot is a slot for the SCS provided by the fourth parameter in the fifth parameter for aperiodic forwarding configuration that is after slot n+k, wherein slot n refers to a slot of a PDCCH reception that provides the DCI and k is the number of slots indicated by a feature group for the SCS of the PDCCH carrying the DCI.

7. The apparatus according to claim 1, wherein the mobile termination transmits a first signal on a control link by using the first timing, the first signal comprising a physical uplink control channel (PUCCH) and/or a Physical Uplink Shared Channel (PUSCH) and/or a Sounding Reference Signal (SRS).

8. The apparatus according to claim 1, wherein the mobile termination transmits a second signal on a control link by a using second timing, the second signal comprising a Physical Random Access Channel (PRACH) and/or an MSGA PUSCH.

9. The apparatus according to claim 1, wherein the timing advance command comprises a first timing advance command and/or a second timing advance command, a quantity of bits included in the first timing advance command being greater than a quantity of bits included in the second timing advance command.

10. The apparatus according to claim 4, wherein the DCI is DCI format 2_8, and/or the first parameter comprises NCR-SemiPersistentFwdResourceSet, and/or the second parameter comprises NCR-PeriodicFwdResourceSet, and/or priority flag comprises priorityFlag, and/or the third parameter for configuring duration comprises durationInSymbols, the fourth parameter comprises referenceSCS, and/or the fifth parameter for aperiodic forwarding configuration comprises NCR-AperiodicFwdConfig, and/or a RNTI dedicated to the repeater comprises NCR-RNTI, and/or the feature group comprises FG 43-3, and/or the number of slots is indicated by slotOffsetAperiodic, and/or the number of symbols is indicated by symbolOffset.

11. The apparatus according to claim 1, wherein the repeater does not expect to change N_{TA} within one slot.

12. The apparatus according to claim 1, wherein the repeater does not expect to change N_{TA} within a third time domain resource.

13. The apparatus according to claim 1, wherein,
for the timing advance command received in a first slot, the timing advance command is applied from a start of a second slot, the second slot being determined according to a reference SCS of a forwarding resource.

14. The apparatus according to claim 13, wherein the second slot being determined according to a reference SCS of a forwarding resource comprises that:
the first slot is determined according to a first SCS related to the reference SCS, and/or,
an offset N_{offset} of the second slot relative to the first slot is determined according to a second SCS related to the reference SCS,
the first SCS and the second SCS being identical or different.

15. The apparatus according to claim 14, wherein,
the first slot is a last slot in an uplink slot/uplink slots based on the first SCS that overlap(s) with a slot of a PDSCH, the PDSCH providing the timing advance command.

16. The apparatus according to claim 15, wherein,
the offset N_{offset} comprises a first offset k,
$$k = ⌈ {N}_{slot}^{subframe , μ} \cdot ( {N}_{T , 1} + {N}_{T , 2} + {N}_{TA , max} + 0.5 ) / {T}_{sf} ⌉ ;$$
$$where ,$$
$${N}_{slot}^{subframe , μ}$$
and/or 2^{μ} is/are determined according to the second SCS.

17. The apparatus according to claim 15, wherein,
the first SCS and/or the second SCS is/are:
a minimum SCS in SCSs of configured UL BWPs and the configured reference SCS(s).

18. The apparatus according to claim 13, wherein the second slot being determined according to a reference SCS of a forwarding resource comprises that:
if a start of a third slot is within a slot based on a third SCS related to the reference SCS, the second slot is after the third slot.

19. The apparatus according to claim 18, wherein,
the second slot is a first one of slots after the third slot with a start aligned with a slot based on the third SCS and/or a first one of slots with a start that is not within a slot based on the third SCS, or,
the second slot is a first one of slots after a slot overlapping with the third slot and/or a first one of slots after the third slot.

20. The apparatus according to claim 18, wherein,
the third SCS is a minimum SCS in the configured reference SCS(s).
